(19) United States
(12) Patent Application Publication
(10) Pub. No.: US 2005/0159148 A1
(43) Pub. Date: Jul. 21, 2005

(54) Radio communication system and radio-frequency integrated circuit

(76) Inventors: Toshihito Habuka, Tamamura (JP); Naoto Inokawa, Takasaki (JP); Tatsuji Matsuura, Tokyo (JP); Toyokazu Hori, Kodaira (JP); Hiroshi Nogami, Fujisawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/033,384

(22) Filed: Jan. 12, 2005

(30) Foreign Application Priority Data
Jan. 21, 2004 (JP) 2004-012691

(51) Int. Cl. H04M 1/00; H04Q 7/20

(52) U.S. Cl. 455/423; 455/562.1

(57) ABSTRACT

In a radio communication system having a plurality of antennas, a reception-system circuit including variable gain amplification circuits for amplifying a signal received from either of the antennas and a frequency conversion circuit for down-converting the received signal to a signal of a lower frequency, and a signal measuring circuit for detecting intensity of the received signal, whereby a signal received by either of the antennas is selected in accordance with a reception state and amplified and demodulated, change rates with time of a signal which is formed by the signal measuring circuit are determined in respect of either of the signals received by the plurality of antennas and a control signal for selecting a reception antenna is generated in accordance with a differences between the change rates.

### INCORPORATION BY REFERENCE

The present application claims priority from Japanese application JP2004-012691 filed on Jan. 21, 2004, the content of which is hereby incorporated by reference into this application.

### BACKGROUND OF THE INVENTION

The present invention relates to a technique for antenna switchover in a radio communication system and more particularly, to a technique effectually applicable to a radio communication system having a plurality of antennas so that either of them may be selected in accordance with a reception state and a signal received by a selected antenna may be amplified and demodulated. For example, the technique of this invention is effectually utilized for a wireless LAN (local area network) system.

Enumerated as radio communication systems put into practice at present are cellular phone systems, wireless LAN systems and Bluetooth systems. Of them, the wireless LAN system is typically constructed of an analog radio-frequency IC having a frequency conversion circuit for down-converting a received signal and up-converting a transmission signal and amplification circuits, an IC chip such as baseband IC including a demodulator for demodulation of the received signal, a modulator for modulation of the transmission signal and adapted to reconstruct received data from demodulated I and Q signals and generate I and Q signals before modulation on the basis of transmission data, and electronic parts such as a power module including a power amplification circuit (power amplifier) for amplifying power of the transmission signal to drive an antenna and an impedance matching circuit and a front module carrying a transmission/reception signal switchover switch and a filter circuit for elimination of unnecessary waves.

In connection with the radio communication systems such as cellular phones and wireless LAN's, a proposal has been made to provide two antennas and switch over the antennas in accordance with a reception state so that a signal having higher reception intensity may be amplified and demodulated by means of a radio-frequency IC (for example, JP-A-2002-368660).

In the conventional antenna switchover technique for use in the radio communication system having a plurality of antennas so that an antenna may be selected in accordance with a reception state, a level of a received signal is detected at a time point during a rise period of the received signal and an antenna to be used is determined on the basis of the detected level, thus completing switchover.

In the conventional antenna switchover method based on the received signal level, however, detection of the received signal level is done at one time point, so that the level detection will be affected adversely by amplitude noises contained in the received signal to sometimes lead to an incorrect level detection by which an improper antenna will be selected.

In addition, the conventional level detection of received signal is carried out on the basis of a signal resulting from down-conversion of a received signal to a signal of a frequency being intermediate between a frequency of a carrier wave and that of a baseband signal (so-called IF signal). In applying the method as above to the wireless LAN, a correct level cannot be detected unless unwanted waves outside a desired frequency band (desired channel) are eliminated and then the received signal level is detected, with the result that a band-pass filter such as SAW filter must be provided which succeeds an IF amplifier adapted to amplify the signal of intermediate frequency (IF) and disadvantageously, the number of parts constituting the system is increased.

### SUMMARY OF THE INVENTION

An object of this invention is to provide a technique capable of selecting a proper antenna without being affected by amplitude noises contained in a received signal in a radio communication system having a plurality of antennas so that a signal received and selected by either of the antennas in accordance with a reception state may be amplified and demodulated.

Another object of this invention is to provide a technique capable of selecting a proper antenna without using expensive, external parts such as SAW filter in a radio communication system having a plurality of antennas so that a signal received and selected by either of the antennas in accordance with a reception state may be amplified and demodulated, whereby the number of parts constituting the system can be decreased, contributing to cost reduction.

Still another object of this invention is to provide a technique capable of selecting a proper antenna within a short period of time and completing gain setting within a short period of time in a reception-system circuit which performs amplification and demodulation of a received signal.

The above and other objects and novel features of this invention will become apparent by reading the description of the present specification in conjunction with the accompanying drawings.

Typically, the present invention disclosed in the present application will be outlined as below.

More particularly, in a radio communication system comprising a plurality of antennas, a reception-system circuit including variable gain amplification circuits for amplifying a signal received by either of the antennas and a frequency conversion circuit for down-converting the received signal to a signal of a lower frequency, and a signal measuring circuit for detecting intensity of the received signal, whereby a signal received by either of the antennas is selected in accordance with a reception condition and amplified and demodulated, change rates with time or temporal change rates of a signal which is formed by the signal measuring circuit are determined in respect of each of the signals received by the plural antennas and a control signal for selecting a reception antenna is generated in accordance with a difference between the change rates.

According to the invention, the reception antenna is selected not on the basis of a level of a received signal but on the basis of change rates of a measured signal and as a result, a proper antenna can be selected without being affected by amplitude noises contained in the received signal.

Further, measurement of a received signal necessary for gain setting of the reception-system circuit is conducted continuously to measurement of the received signal necessary for antenna selection. This permits the gain setting in the reception-system circuit to be completed within a short period of time.

Meritorious effects typically obtained by this invention disclosed in the present application will be described briefly as below.

More specifically, according to teachings of this invention, in the radio communication system having a plurality of antennas so that a signal received by either of the antennas in accordance with a reception state may be amplified and demodulated, a proper antenna can be selected under no influence of amplitude noises contained in the received signal.

### BRIEF DESCRIPTION OF THE DRAWINGS

FIG. 1 is a block diagram showing an example of construction of radio-frequency IC and baseband LSI circuit constituting a radio communication system to which this invention can be applied preferably.

FIG. 2 is a block diagram showing an example of construction of a first signal level measuring circuit 280 provided in the radio-frequency IC.

FIG. 3 is a block diagram showing an example of construction of a second signal level measuring circuit 360 provided in the baseband LSI circuit.

FIG. 4 is a circuit diagram showing a concrete circuitry example of a correction circuit for correction of DC offset and gain built in the baseband LSI circuit according to the embodiment.

FIG. 5 is a graph showing characteristics indicative of the relation between input signal level and output voltage in the first signal level measuring circuit according to the embodiment.

FIG. 6 is a block diagram showing an example of construction of an averaging filter.

FIG. 7A is a block diagram showing the construction of a high-gain amplifier incorporated in the radio-frequency IC.

FIG. 7B is a graphic representation useful to explain level distribution of frequency components of signals at respective portions in the high-gain amplifier.

FIG. 8 is a block diagram showing an example of construction of a variable gain amplification circuit constituting the high-gain amplifier according to the embodiment.

FIG. 9 is a block diagram showing an example of construction of a control circuit built in the baseband LSI circuit.

FIG. 10 is a flowchart showing an example of procedures in a reception operation process by the control circuit incorporated in the baseband LSI circuit.

FIG. 11 is a timing chart showing timings of various signals in the radio communication system to which the radio-frequency IC and baseband LSI circuit according to the embodiment are applied.

FIG. 12 is a diagram useful to explain an example of structure of a packet in a wireless LAN pursuant to IEEE802.11a standard.

FIG. 13A is a timing chart showing a more precise output waveform of an averaging filter 350 when a received signal level at an antenna A is higher.

FIG. 13B is a timing chart showing a more precise output waveform of the averaging filter 350 when a received signal level at an antenna B is higher.

### DESCRIPTION OF THE EMBODIMENTS

Preferred embodiments of the invention will now be described with reference to the accompanying drawings.

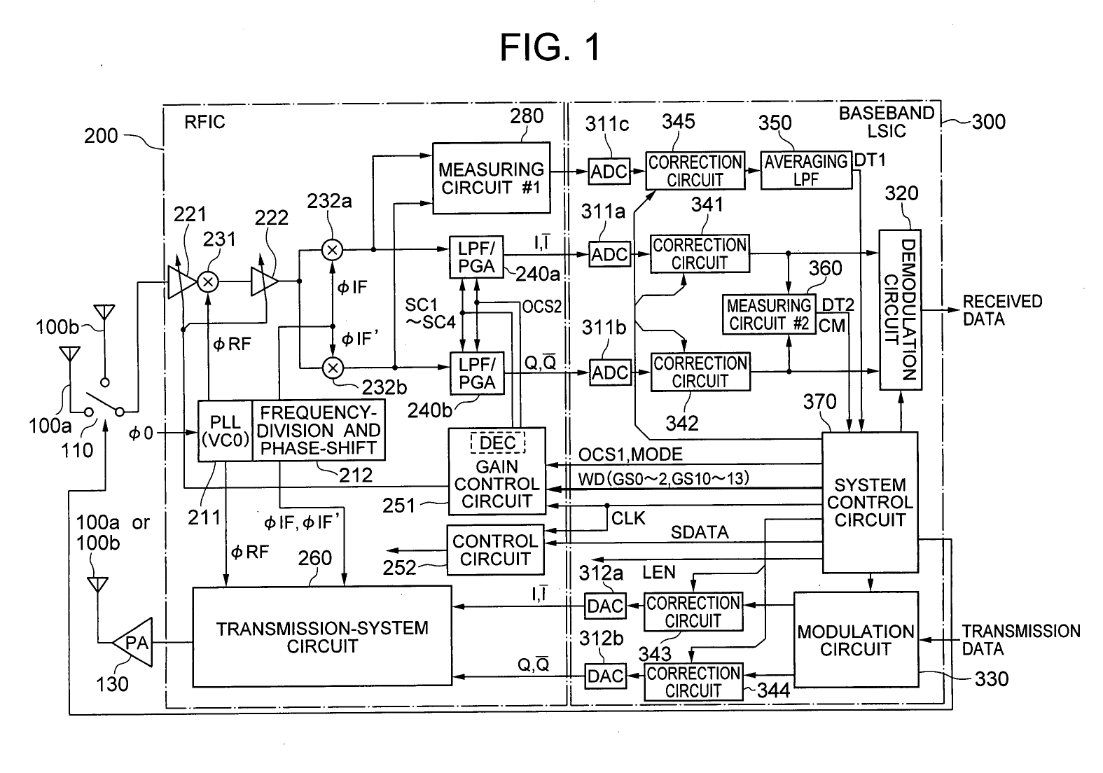

FIG. 1 illustrates an embodiment of a radio communication system to which this invention is preferably applied and which is constructed of a radio-frequency IC and a baseband LSI circuit.

The radio communication system of the present embodiment comprises antennas 100a and 100b for performing transmission and reception of a signal electric wave, a switchover switch 110 for switching the antennas, a power amplifier 130 for power-amplifying a transmission signal and transmitting it through the antenna 100a or 100b, a radio-frequency IC for down-converting a received signal and up-converting a transmission signal, and a baseband LSI circuit 300 for performing a modulation/demodulation process and a baseband process. Although not specifically restricted, the antenna switchover switch 110 can be switched with a control signal from a control circuit 370 of the baseband LSI circuit 300. The antennas 100a and 100b are located at different positions which are, for example, several centimeters spaced from each other. Though not illustrated, a transfer switch for switching transmission and reception is also provided. During the transmission mode, the output of power amplifier 130 is connected to any one of the antennas 100a and 100b by means of the transfer switch (not shown).

In FIG. 1, other components than the radio-frequency IC 200 and baseband LSI circuit 300 are depicted in a simplified fashion. In a practical system, the power amplifier 130 is configured, together with an impedance matching circuit and a filter for elimination of higher harmonics, in the form of a module (power module) on an insulating substrate such as ceramic substrate. Though not restricted particularly, circuits constituting the radio-frequency IC 200 are formed on a single semiconductor substrate of, for example, SiGe and the baseband LSI circuit 300 is formed with a circuit using CMOS's on a single semiconductor substrate of silicon, for instance. This permits the radio-frequency IC 200 to easily acquire operation speeds necessary for performing up-converting and down-converting operations and the baseband circuit LSI circuit 300 to operate at low consumptive power. Interposed between the antenna switchover switch 110 and the radio-frequency IC 200 is a band-pass filer for elimination of unwanted waves from a received signal. This band-pass filter is not a narrow band-pass filer such as SAW filter but may be a filter constructed of capacitive elements and inductor elements to have a band width of several of hundreds of MHz. The antenna switchover switch 110 and band-pass filter are configured in the form of a module (front-end module) on an insulating substrate other than that for the power module. Then, these modules and the radio-frequency IC 200 and baseband LSI circuit 300 are packaged on a single printed circuit board, thus forming the radio communication system.

The radio frequency IC 200 includes a PLL circuit 211 having a VCO (voltage-controlled oscillator) responding to a reference signal φ0 supplied externally of the IC chip to generate a radio-frequency signal φRF having a higher frequency than the signal φ0, a frequency-division phase-shift circuit 212 adapted to frequency-divide the radio-frequency signal φRF to generate signals φIF and φIF′ which are 90° dephased from each other, a low-noise amplifier 221 for amplifying a signal received by the antenna, a mixer 231 for mixing the received signal, amplified by the low-noise amplifier 221, with the radio-frequency signal φRF generated by the PLL circuit 211 so as to down-convert the received signal into a signal of intermediate frequency (IF), an IF amplifier 222 for further amplifying the down-converted received signal, mixers 232a and 232b for mixing the amplified received signal with the mutually 90° dephased signals φIF and φIF′ so as to down-convert the amplified received signal to resulting signals of a more lower frequency which provide separated I and Q signals, high-gain amplifiers 240a and 240b each having a low-pass filter (LPF), a variable gain amplifier (PGA) and an offset cancel circuit and adapted to amplify the I and Q signals to predetermined amplitude levels, respectively, while eliminating unwanted waves, a gain control circuit 251 for controlling gains of the high-gain amplifiers 240a and 240b and of the amplifiers 221 and 222, and a signal level measuring circuit 280 for receiving the outputs of the mixers 232a and 232b to detect an approximate amplitude level of the received signal.

As shown in FIG. 1, in the present embodiment, the signal level measuring circuit 280 is so constructed as to measure the signal level not on the basis of the signal of intermediate frequency (IF) amplified by the IF amplifier 222 but on the basis of the signal down-converted to the baseband frequency band by means of the mixers 232a and 232b. Such a signal as above is of a low frequency and therefore, time required for measurement of its signal level is prolonged as compared to the case where the signal level measurement is carried out on the basis of the signal of intermediate frequency (IF), with the result that times allowed to effect offset cancel and gain setting in the high-gain amplifiers 240a and 240b are shortened. But, by executing the offset cancel and gain setting in a manner to be described later, the times required for the offset cancel and gain setting can be decreased, thereby ensuring that the signal level measurement based on the signal down-converted to the baseband frequency band can be conducted within an ample time and any SWA filter need not be provided between the IF amplifier 222 and the signal level measuring circuit 280.

The gain control circuit 251 responds to offset cancel control signal OCS1, mode signal MODE and control data WD inclusive of gain setting codes GS0 to GS2 and GS10 to GS13, these signals being supplied from the system control circuit 370 of baseband LSI circuit 300, to generate an offset cancel operation start commanding signal OCS2 and gain switchover control signals SC1 to SC4 for the high-gain amplifiers 240a and 240b and amplifiers 221 and 222 and supply these signals to the amplifiers. Though not particularly limited, the gain control circuit 251 is provided with a decoder DEC for decoding the gain setting codes GS0 to GS2 and GS10 to GS13.

The radio-frequency IC 200 further includes a low-pass filter for elimination of higher harmonics contained in I and Q signals on the transmission side, a transmission-system circuit 260 which performs quadrature modulation by mixing the I and Q signals having passed through the low-pass filter with the mutually 90° dephased signals φIF and φIF′ from the frequency-division phase-shift circuit 212 and up-converts the resulting I and Q signals to signals of higher frequency so as to deliver them to the power amplifier 130, and a control circuit 252 responsive to commands from the baseband LSI circuit 300 to generate control signals internal of the chip.

The control circuit 252 is supplied, from the system control circuit 370 of baseband LSI circuit 300, with clock signal CLK for synchronization, data signal SDATA and load enable signal LEN serving as a control signal and when the load enable signal LEN is asserted to an effective level, the control circuit 252 sequentially fetches the data signal SDATA transmitted from the baseband circuit 300 in synchronism with the clock signal CLK and generates control signals for the interior of the radio-frequency IC 200 on the basis of the received control command and control data. Though not particularly limited, the data signal SDATA is transmitted serially.

The gain control circuit 251 for parallel data transmission is provided separately from the control circuit 252 because as will be described later, the gain setting must be completed within a very short period of time upon reception operation start and in that case, transmission of the gain control data WD based on serial data transmission as in the control circuit 252 will be retardative. On the other hand, excepting the gain setting, the internal state switching and setting in the radio-frequency IC 200, for instance, leave plenty of room for time and therefore, commands can be supplied from the baseband LSI circuit 300 to the control circuit 252 in the serial transmission fashion as in the case of the present embodiment. The control circuits 251 and 252 can be constructed integrally but by providing them separately, circuit design can be facilitated.

The baseband LSI circuit 300 includes AD conversion circuits 311a and 311b for converting I and Q signals on the receiving side delivered out of the radio-frequency IC 200 into digital signals, respectively, a demodulation circuit 320 for reconstructing the received data by demodulating the digital I and Q signals, a modulation circuit 330 for generating digital I and Q signals by modulating transmission data, and DA conversion circuits 312a and 312b for converting the digital I and Q signals into analog I and Q signals.

The baseband LSI circuit 300 further includes correction circuits 341 and 342 for correcting characteristics (gain and offset) of the reception-system circuit, correction circuits 343 and 344 for correcting characteristic of the transmission-system circuit, an AD conversion circuit 311c for converting the detection signal delivered out of the signal level measuring circuit 280 of radio-frequency IC 200 into a digital signal, a correction circuit 345 for correcting characteristics of the measurement-system circuit (signal level measuring circuit 280 and AD conversion circuit 311c), an averaging filter 350 for temporally averaging the output of the AD conversion circuit 311c, a second signal level measuring circuit 360 for measuring a strict amplitude level of the received signal from outputs of the AD conversion circuits 311a and 311b, and the system control circuit 370 for generating control signals for circuits internal of the chip, generating gain control data which controls the gain of the reception-system circuit in the radio-frequency IC 200 on the basis of outputs of the averaging filter 350 and second signal level measuring circuit 360 so as to transmit the gain control data to the radio-frequency IC 200 and detecting errors occurring in the reception-system circuit, transmission-system circuit and measurement-system circuit to generate correction control signals which cause the correction circuits 341 to 345 to correct the errors. In the present specification, a component inclusive of the signal level measuring circuit 280, AD conversion circuit 311c and averaging filter 350 will sometimes be called a signal level measuring circuit in a broad sense.

The system control circuit 370 can be constructed of a circuit as shown in FIG. 9 which is constructed similarly to a general-purpose microcomputer or microprocessor operating on the basis of programs. The wireless LAN system pursuant to the IEEE802.11a standard uses an OFDM (orthogonal frequency division multiplex) method as modulation method and when the present embodiment is applied to the wireless LAN system, the baseband LSI circuit 300 is so constructed as to enable the demodulation circuit 320 and modulation circuit 330 to perform modulation/demodulation pursuant to the OFDM method.

Next, a concrete example of construction of the signal level measurement-system circuit (280, 360 and so on) will be described. In the present embodiment, the measuring circuit 280 for roughly detecting the level of a signal and the second measuring circuit 360 for more strict detection are provided for the measurement-system circuit for reasons as below. More particularly, in the wireless LAN system of IEEE802.11a standard, as a received signal inputted to the high-gain amplifiers 240a and 240b, a signal which ranges from −82 dB to −30 dB to have a maximum level difference of nearly 400 times is permitted. Accordingly, if this type of signal is directly AD converted by using an AD conversion circuit of, for example, 10 bits, the conversion accuracy cannot be so high. Then, in the present embodiment, levels of the I and Q signals are first detected roughly by means of the first measuring circuit 280 in order that gains of the high-gain amplifiers 240a and 240b can be controlled roughly on the basis of the detection results to narrow down the range of signal levels and thereafter the signal levels can be measured strictly by means of the second measuring circuit 360 to more accurately set the gains of high-gain amplifiers 240a and 240b.

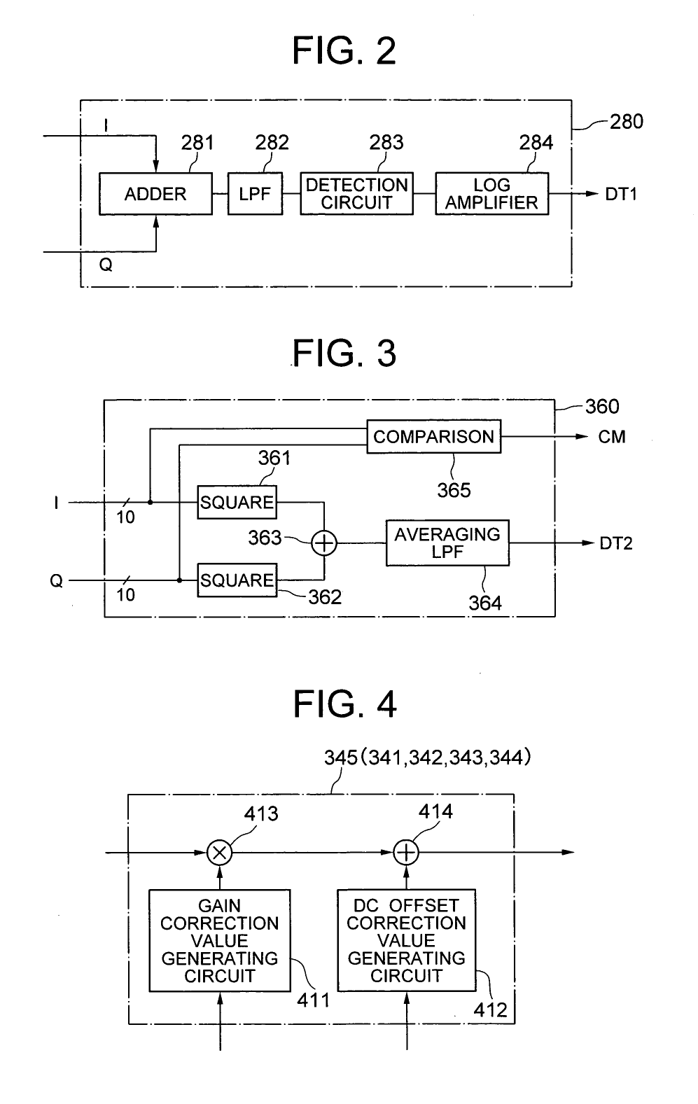

FIG. 2 illustrates an example of construction of the signal level measuring circuit provided in the radio-frequency IC 200. The signal level measuring circuit 280 in this embodiment has an adder 281 for adding I and Q signals, a low-pass filter 282 for eliminating unwanted waves from an added signal, a detection circuit 283 for rectifying a signal (alternating) having passed through the low-pass filter 282 to convert it into a DC signal, and a Log amplifier 284 for logarithmically compressing the converted signal to deliver a detected value DT1. The logarithmically compressed detected value DT1 is converted into a digital signal by means of the AD conversion circuit 311c and is supplied to the system control circuit 370. Instead of providing the output detection circuit 283 and Log amplifier 284 separately, a circuit capable of performing detection and logarithmic compression at a time may be employed.

The Log amplifier 284 for logarithmic compression is provided because as described previously, the received signal inputted to the high-gain amplifiers 240a and 240b is a signal which ranges from −82 dB to −30 dB to have a maximum level difference of about 400 times. When the output voltage of the measuring circuit is limited to such a narrow range of from 0.5 to 1.5V, the logarithmic compression can permit the output voltage change to be larger at a small signal level than at a large signal level, that is, can make the sensitivity to a small-level signal higher.

FIG. 4 illustrates an example of construction of the correction circuit 345 succeeding the signal level measuring circuit 280. The remaining correction circuits 341 to 344 are constructed similarly, though not illustrated. The correction circuit 345 in the present embodiment has gain correction value generating circuit 411 and offset correction value generating circuit 412 which are adapted to generate a correction value for gain and a correction value for offset, respectively, on the basis of control data supplied from the system control circuit 370, a multiplication circuit 413 for multiplying the correction value generated from the gain correction value generating circuit 411 by a measured value from the AD conversion circuit 311c, and an addition circuit 414 for adding an output value of the multiplication circuit 413 and the correction value generated from the offset correction value generating circuit 412.

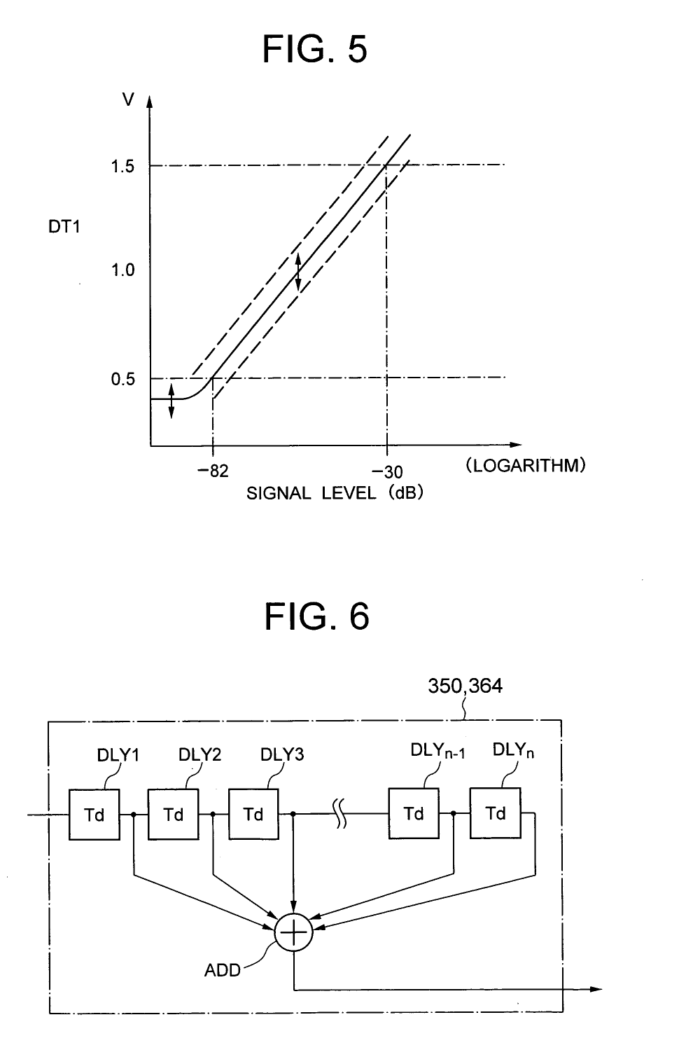

The signal level measuring circuit 280 shown in FIG. 2 is so designed that its output DT1 is substantially linearly related to the input signal level as shown at solid line in FIG. 5. Actually, however, because of irregularities in manufacture of devices, the gain characteristic of a signal path between the input terminal of signal level measuring circuit 280 and the output terminal of averaging filter 350 (see FIG. 1) sometimes changes as shown at dashed line and arrow in FIG. 5 or the linearity is sometimes impaired. Accordingly, in this embodiment, the gain is corrected with the correction circuit 345 in order that the output DT1 of measuring circuit 280 can be placed in the predetermined relationship to the signals in the range of from −82 dB to −30 dB.

Also, the output DT1 of first measuring circuit 280 is saturated near −82 dB to cause the output not to change linearly to a signal having a certain level or less as shown in FIG. 5 and besides the saturation point increases or decreases owing to irregularities in manufacture of devices. Accordingly, in the present embodiment, in order to guarantee the linear change of output DT1 of the measuring circuit 280 in relation to the signal in the range of from −82 dB to −30 dB, the offset is corrected with the correction circuit 345. In FIG. 5, the signal level on abscissa is represented in terms of logarithmic scale.

FIG. 3 illustrates an example of construction of the second signal level measuring circuit 360 provided in the baseband LSI circuit 300. The second signal level measuring circuit 360 in the present embodiment has square circuits 361 and 362 for squaring I and Q signals, respectively, an adder 363 for adding squared values, an averaging filter 364 for temporally averaging added values, and a comparison circuit 365 for comparing the inputted I and Q signals. A detected value DT2 corresponding to a signal level of the I and Q signals totaled within a predetermined time is delivered out of the averaging filter 364. The comparison circuit 365 decides which one of levels of the I and Q signals is larger and delivers a signal CM indicative of a decision result.

The detected value DT2 and the signal CM indicative of the magnitude decision result from the second signal level measuring circuit 360 are supplied to the system control circuit 370. It is to be noted that the second signal level measuring circuit 360 in this embodiment is a digital circuit in contrast to the signal level measuring circuit 280 of FIG. 2 and its inputs I and Q are also digital values. The signal CM indicative of the magnitude decision result is utilized when gain balance correction between I and Q sides in the aforementioned transmission-system circuit and gain balance correction between I and Q sides in the reception-system circuit are carried out, thus facilitating obtainment of the result of gain magnitude decision.

The averaging filter 364 is a circuit constructed similarly to the averaging filter 350 succeeding the correction circuit 345 and as shown in FIG. 6, it has a plurality of delay circuits DLY1, DLY2 . . . DLYn (n: integer number 1 or larger) connected in tandem and an adder ADD for adding signals delayed by means of the respective delay circuits. Though not restricted particularly, each of the delay circuits DLY1, DLY2 . . . DLYn is so designed as to have a delay time Td equal to the period of sampling clock Us for each of the AD conversion circuits 311a to 311c.

The delay circuit as above can be constructed of, for example, latch circuits or flip-flops for fetching input data synchronously with a clock. Accordingly, the delay circuits DLY1, DLY2 . . . DLYn can be deemed as a shift register. In case the level of a received signal is constant in the averaging filter of FIG. 6, the filter output representing the total of outputs of the respective delay circuits increases gradually during an interval between inputting of the first input signal to the delay circuit DLY1 and arrival of the signal at the delay circuit DLYn but thereafter, the filter output assumes a substantially constant value.

In the averaging filter 350, the number of delay stages “n” (n being positive integer) is set such that a signal inputted to the delay circuit DLY1 is delivered out of the final stage delay circuit DLYn after 0.8 μs. Here, 0.8 μs corresponds to the period of one pattern of heading preamble pattern in a packet stipulated by the wireless LAN standard. Though not particularly limited, in the present embodiment, the signal propagation time between the input and output terminals of the averaging filter 364 is set to, for example, 1 μs. The input to each of the averaging filters 350 and 364 has a bit number complying with the resolution of the corresponding AD conversion circuit 311a, 311b or 311c. More specifically, in this embodiment, the input to the averaging filter 350 is of 4 bits and the input to the averaging filter 364 is of 10 bits.

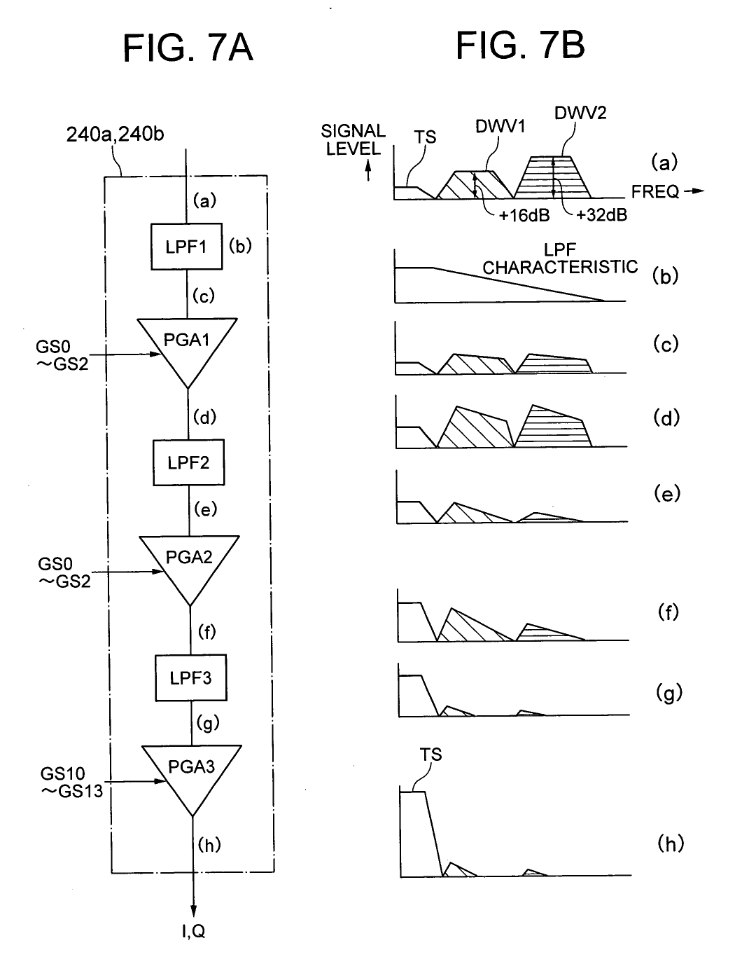

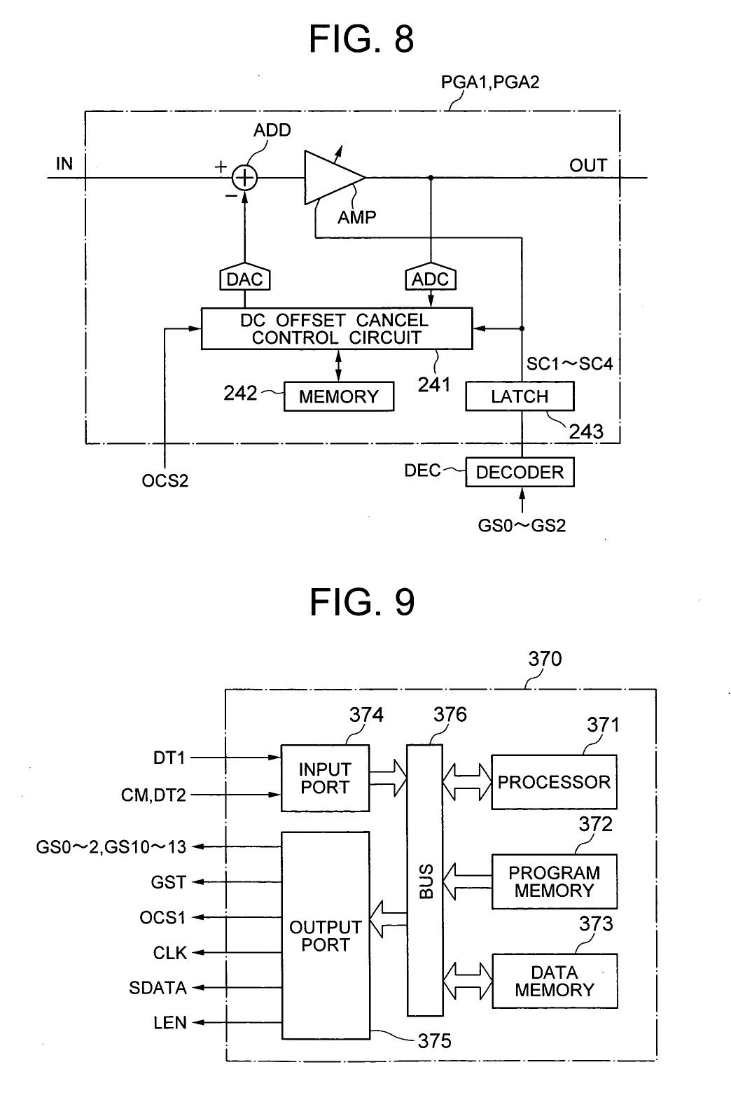

An example of concrete construction of each of the high-gain amplifiers 240a and 240b will be described with reference to FIGS. 7A and 7B and FIG. 8.

As shown in FIG. 7A, each of the high-gain amplifiers 240a and 240b has low-pass filters LPF1, LPF2 and LPF3 and gain control amplification circuits PGA1, PGA2 and PGA3 which are connected alternately in series. Gains of the gain control amplification circuits PGA1, PGA2 and PGA3 are controlled by gain control data GS0-GS2 and GS10-GS13, respectively.

The low-pass filters LPF1, LPF2 and LPF3 and the gain control amplification circuits PGA1, PGA2 and PGA3 are connected alternately in series as shown in FIG. 7A for the reasons as below. More particularly, when, as shown at (a) in FIG. 7B depicting frequency components of an input to the low-pass filter LPF1, a target received signal TS has a level smaller than levels of interference wave DWV1 of adjacent channel and interference wave DWV2 of spaced channel, an abrupt amplification of the target received signal TS to a desired level is accompanied by amplification of the interference waves at the same rate. But by using a characteristic of low-pass filter as shown at (b) to amplify the target received signal TS while suppressing the interference waves of higher frequencies stepwise as shown at (c) to (g), only the target received signal TS can be amplified to the desired level as shown at (h).

As shown in FIG. 8, the first and second stages of gain control amplification circuits PGA1 and PGA2 have each a variable gain amplifier AMP, an adder ADD preceding it, an AD converter ADC for converting the output of variable gain amplifier AMP to a digital signal, an offset cancel control circuit 241, a memory circuit 242 comprised of a RAM or register and adapted to store an offset cancel value detected by the offset cancel control circuit 241, a DA converter DAC for converting the offset cancel value stored in the memory circuit 242 into an analog value, and a latch circuit 243 for latching gain switching signals SC1 to SC4. The third stage of gain control amplification circuit PGA3 is materialized with a circuit of FIG. 8 removed of the memory circuit 242.

When, in each of the first and second stages of gain control amplification circuits PGA1 and PGA2, the offset cancel control circuit 241 receives from the control circuit 252 a command signal OCS2 to start an offset cancel operation, it detects an offset of the variable gain amplifier AMP from an output of the AD converter ADC and generates a value for making the offset “0” (offset cancel value) which in turn is stored in the memory circuit 242. A method for detection of this type of offset is disclosed in, for example, U.S. patent application Publication No.2002/0094792A1. Since the offset cancel value can be determined through sequential comparison operation by means of the AD converter ADC, the AD converter ADC can be constructed of a simplified circuit having a comparator and a resistance-type potential division circuit for applying comparison voltages to the comparator.

In the radio communication system of the present embodiment, generation and storage of the offset cancel value is carried out during a spare time such as for power supply turn on, switching from transmission to reception and wait by causing the system control circuit 370 of baseband LSI circuit 300 to forward a predetermined command to the control circuit 252. Then, when gain control data WD1 is sent to the gain control circuit 251 during reception operation start, the control circuit reads out the offset cancel value stored in the memory circuit 242 responsively and supplies it to the DA converter DAC, thereby enabling the adder ADD to cancel out the offset.

On the other hand, when the offset cancel control circuit 241 in the third stage of gain control amplification circuit PGA3 receives from the gain control circuit 251 a command signal OCS2 to start offset cancel operation, it undertakes offset detection and cancel operation on real time base.

In connection with the offset cancel in the reception-system circuit, a method is conceivable in which during reception start operation, all of the first to third stages of amplifiers conduct offset detection and cancellation substantially simultaneously but by detecting an offset in advance and storing an offset cancel value as in the case of the present embodiment, the offset cancel operation can be ended within a short period of time and a reception operation can be started to advantage.

When gain setting codes GS0 to GS2 for designating the gain of the variable gain amplifier AMP of gain control amplification circuits PGA1 or PGA2 are supplied from the control circuit 251 during start of reception operation, the offset cancel control circuit 241 reads an offset cancel value corresponding to the gain setting codes GS0 to GS2 from the memory circuit 242 and supplies it to the DA converter DAC, so that the adder ADD adds to the input the offset cancel value to thereby cancel a DC offset of the amplifier.

To add, as shown in FIG. 8, a decoder DEC for decoding the gain setting codes GS0 to GS2 to generate signals SC1 to SC4 for actual switchover control can be provided near each of the gain control amplification circuits PGA1 and PGA2 but in the present embodiment, the decoder DEC for decoding the gain setting codes GS0 to GS2 is provided in the gain control circuit 251 of FIG. 1.

Next, procedures for antenna switchover control and gain control in the reception-system circuit inclusive of the high-gain amplifiers 240a and 240b in the present embodiment will be described.

In the present embodiment, the antenna switchover control and gain control in the reception-system circuit are accomplished by means of the system control circuit 370 in baseband LSI circuit 300. The system control circuit 370 is constructed similarly to a general-purpose microcomputer operating on the basis of programs and has, as shown in FIG. 9, a CPU (central processing unit) 371 for performing various kinds of operation processes and generating control signals in accordance with instructions in programs, a program memory 372 comprised of a ROM (read only memory) for storing the programs executed by the CPU and fixed data necessary for execution of the programs, a data memory 373 comprised of a RAM (random access memory) for offering working areas of the CPU and storing temporary data such as operation results, an input port 374 to which signals from the averaging filter 350 and second signal level measuring circuit 360 in FIG. 1 are inputted, an output port 375 for delivering control signals to the circuits internal of the chip, such as the correction circuits 341 to 345, and control signals and control data to the gain control circuit 251 and control circuit 252 internal of radio-frequency IC, and a bus 376 for coupling these circuit blocks.

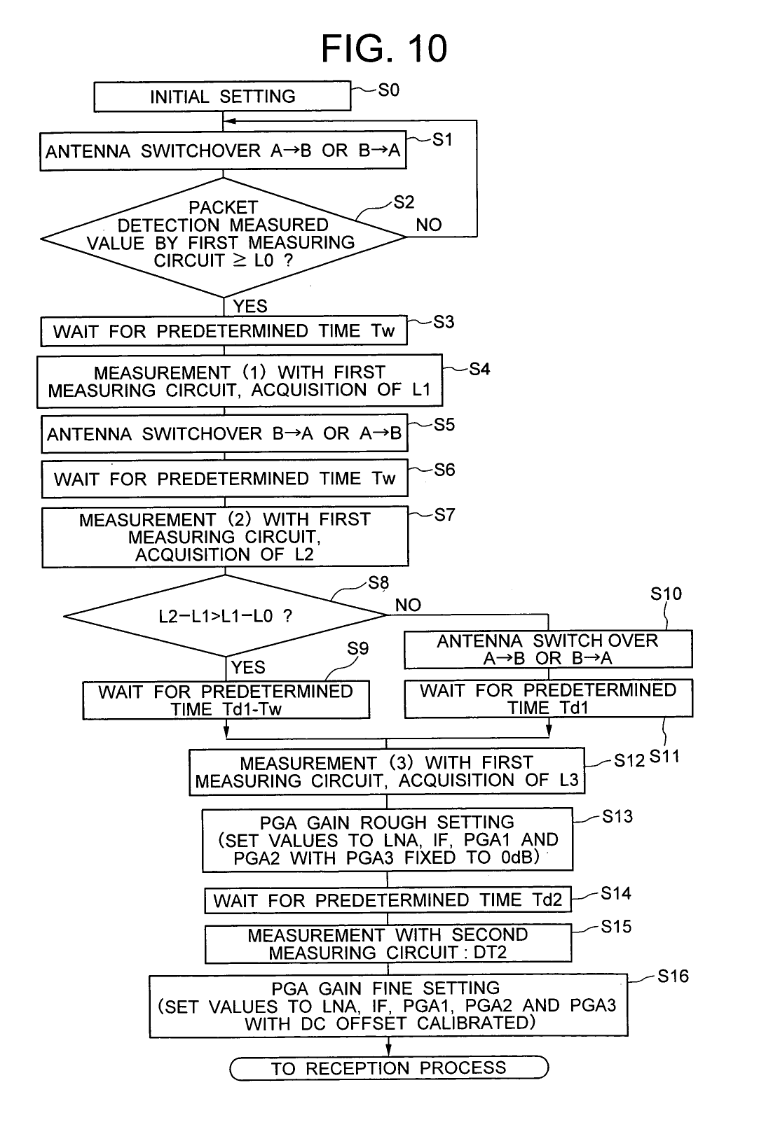

When determining that the operation mode has shifted to the reception mode, the system control circuit 370 starts control in accordance with a flowchart shown in FIG. 10.

In reception operation control, the system control circuit 370 first sends a DC offset cancel control signal OCS1 to the radio-frequency IC 200 (step S0). Then, in the radio-frequency IC 200, the low-noise amplifier 221, IF amplifier 222 and variable gain amplifiers PGA1 to PGA3 in high-gain amplifiers 240a and 240b are set to arbitrary initial gains.

Thereafter, the system control circuit 370 controls the switch 110 to select the antenna A (100a) or B (100b) and by consulting a detected value DT1 from the averaging filter 350, decides whether the output of signal level measuring circuit 280 exceeds a preset stipulated value (L0), so as to detect the presence or absence of a received packet (steps S1 and S2). With no received packet detected, the program returns to the step S1, in which switchover to the other antenna is done and the presence or absence of a received packet is detected (step 2). The above procedure repeats itself until a received packet is detected. Then, with a received packet detected, the system control circuit 370 waits for a predetermined time Tw (for example, 0.1 μs) and thereafter fetches an output of averaging filter 350 as a detected value L1 of first signal level measuring circuit 280 (steps S3 and S4).

Subsequently, the antenna is switched to one on the opposite side (A to B or B to A) and after the predetermined time Tw again waited for, an output of averaging filter 350 is fetched as a detected value L2 of first signal level measuring circuit 280 (steps S5 to S7). Then, a change rate of the received signal in the first measurement (difference L1−L0 between measured values L1 and L0) is compared with a change rate of the received signal in the second measurement (difference L2−L1 between measured values L2 and L1) to determine which one of the changes rates is lager (step S8). If (L2−L1)>(L1−L0) now stands, the antenna selection state is made to be intact and a lapse of predetermined time (Td1−Tw) is waited for in step 9 and the program proceeds to step S12. On the other hand, if (L2−L1)<(L1−L0) stands, the antenna is switched over to the opposite connection, that is, returned to the previous connection (step S10) and at the termination of a predetermined time (Td1) in step S10, the program proceeds to the step S12.

Here, the predetermined time Td1 corresponds to a delay time required for the received signal to reach the output terminal of averaging filter 350 from the antenna switchover switch, that is, a time required for the output of averaging filter 350 to stabilize. When (L2−L1)>(L1−L0) stands, the predetermined time is made to be shorter by Tw as indicated by (Td1−Tw). This is because the second measurement is carried out continuously to the first measurement while keeping the first measurement state and hence the shorter stabilization period of the filter output suffices.

In the step S12, the system control circuit 370 again fetches an output of average filter 350 as a detected value DT1 of signal level measuring circuit 280. Then, by consulting a data table in the data memory 373 and responding to a detected value L3 of signal level measuring circuit 280, the system control circuit 370 determines approximately gains of the low-noise amplifier 221 and IF amplifier 222 and of the gain control amplification circuits PGA1 and PGA2 in high-gain amplifiers 240a and 240b in such a manner that levels of received I and Q signals inputted to the baseband LSI circuit 300 can fall within a predetermined range and delivers gain control data GS0 to GS2 and GS10 to GS13 and offset cancel control signal OCS1 to the gain control circuit 251 of radio-frequency IC 200 (step S13).

Through this, in the radio-frequency IC 200, rough gain setting of the amplifiers used is carried out in the first and second stages of gain control amplifier circuits PGA1 and PGA2 and besides offset cancel values conforming to the used amplifiers are read out of the memory circuit 242 (FIG. 8) to cancel the DC offset. In this phase, the gain of the third stage of gain control amplification circuit PGA3 in each of the high-gain amplifiers 240a and 240b is set to, for example, “0 dB” by gain control data GS10 to GS13.

When the rough gain setting ends, the system control circuit 370 waits for a predetermined time Td2 (step S14). The time Td2 corresponds to a delay time required for a received signal to reach the output terminal of second signal level measuring circuit 360 from the antenna switchover switch via the high-gain amplifiers 240a and 240b, that is, a time required for I and Q signals delivered out of the high-gain amplifiers 240a and 240b to stabilize. At the termination of the Td2 time, the system control circuit 370 fetches an output value DT2 of second signal level measuring circuit 360 (step S15).

Next, by consulting the data table in the data memory 373 and responding to the detected value DT2 of signal level measuring circuit 360, the system control circuit 370 determines gains of the low-noise amplifier 221 and IF amplifier 222 and of the gain control amplification circuits PGA1, PGA2 and PGA3 in high-gain amplifiers 240a and 240b in such a manner that levels of the received I and Q signals inputted to the baseband LSI circuit 300 coincide with a predetermined level and delivers gain control data GS0 to GS2 and GS10 to GS13 and offset cancel control signal OCSI to the gain control circuit 251 of radio-frequency IC 200 (step S16).

Through this, in the radio-frequency IC 200, fine gain setting of amplifiers used is carried out in the gain control amplification circuits PGA1, PGA2 and PGA3 and besides set gains, that is, offset cancel values conforming to the used amplifiers are read out of the memory circuit 242 to cancel the offset. Further, in the third stage of gain control amplification circuit PGA3, DC offset detection and operation of canceling the offset are executed on real time base. When the fine gain setting ends, the system control circuit 370 waits until the I and Q signals delivered out of the high-gain amplifiers 240a and 240b are stabilized and thereafter shifts to a reception process.

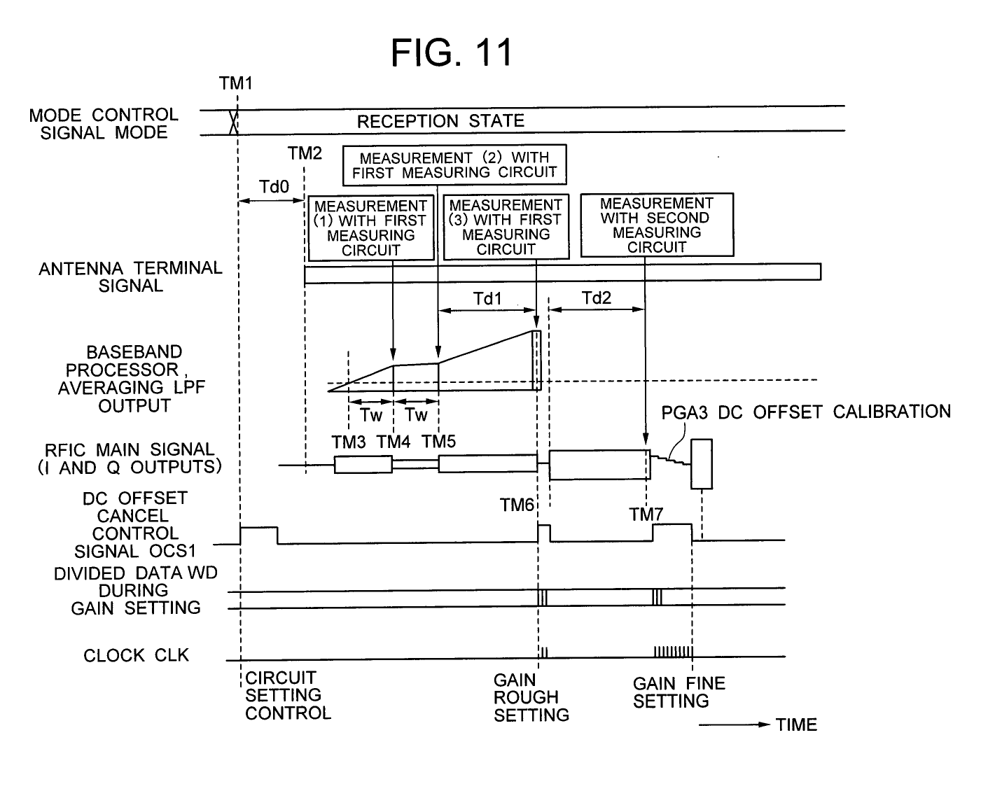

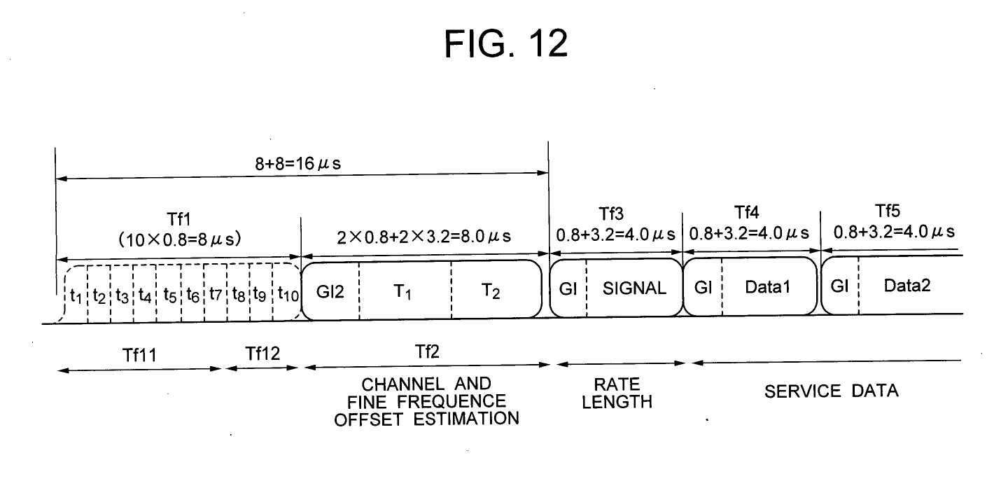

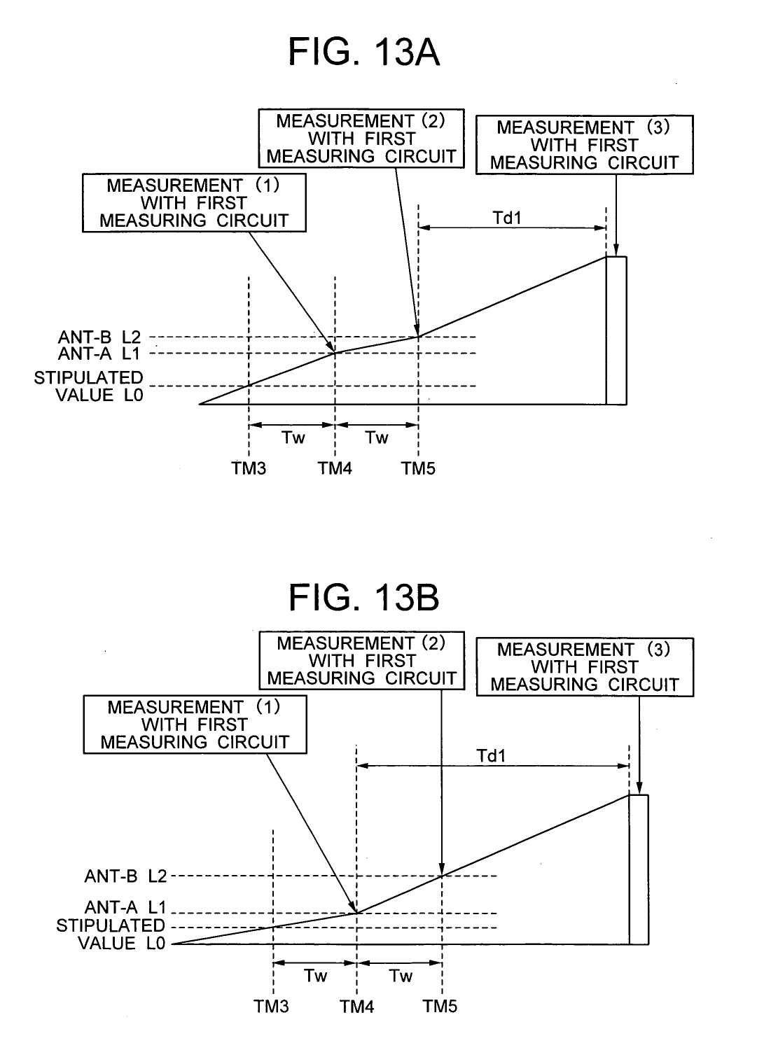

FIG. 11 depicts timings of various signals when the system control circuit 370 executes the control in accordance with the flowchart of FIG. 10 and FIG. 12 depicts a pattern structure of the head portion of a packet transmitted/received in the wireless LAN system pursuant to the IEEE802.11a standard. Further, FIG. 13A illustrates a more precise output waveform of averaging filter 350 when the antenna A is at a higher received signal level and FIG. 13B illustrates a more precise output waveform of averaging filter 350 when the antenna B is at a higher received signal level.

As shown in FIG. 11, the system control circuit 370 sends a DC offset cancel control signal OCS1 to the radio-frequency IC at timing TM1 that the mode signal switches to a reception state. Then, after an arbitrary time Td0 has elapsed, a received signal begins to enter the radio-frequency IC 200 via the antenna (timing TM2). A little later, the output of averaging filter 350 begins to rise gradually and concurrently therewith, I and Q signals begin to be delivered out of the radio-frequency IC 200.

As shown in the packet structure of FIG. 12, the wireless LAN standard stipulates that a short symbol period Tf1 (8 μs) within which a pattern having a period of 0.8 μs (preamble pattern) is repeated 10 times be provided in the head of a transmission/reception packet, that packet detection, antenna switching and gain control be performed within a period Tf11 for initial seven repetitions of pattern (t1 to t7) and that frequency-locking in the PLL circuit 211 of FIG. 1, DC offset adjustment of amplifiers and timing synchronization be done within a period Tf12 for the remaining three repetitions of pattern (t8 to t10). The standard further stipulates that after the short symbol period Tf1, a long symbol period period Tf2 (8 μs) consisting of a card interval GI2 of 1.6 μs and two patterns T1 and T2 each having the same 3.2 μs period as the data area be provided and that fine adjustment of frequencies and DC offset be done within the long symbol period Tf2.

In the baseband LSI circuit 300 of the present embodiment, the output of averaging filter 350 is fetched into the control circuit 370 of baseband LSI as detected value L1 of first signal level measuring circuit 280 at a timing TM4 at which a predetermined time Tw has elapsed from the timing TM3 of FIG. 11 that the output of averaging filter 350 having started rising reaches a stipulated value L0. Then, the antenna is switched (A to B) at this timing and the output from the averaging filter 350 is fetched as detected value L2 of signal level measuring circuit 280 at a timing TM5 at which the predetermined time Tw has again elapsed. In the wireless LAN system pursuant to the IEEE802.11a standard, it is stipulated that a signal of −82 dB can be detected as received signal and therefore, the aforementioned stipulated value L0 may preferably be set to a value which is higher than the noise level and corresponds to the −82 dB or a value corresponding to a level slightly lower than −82 dB allowing a margin for −82 dB.

The output of averaging filter 350 differs in its rise speed (change rate) depending on the magnitude of received signal level. In the baseband LSI circuit 300 of this embodiment, the antenna to be selected is determined by causing the control circuit 370 to compare a difference L1−L0 between measured value L1 and stipulated value L0 in the first measurement with a difference L2−L1 between measured values L2 and L1 in the second measurement so as to decide which one of them is larger, as described previously. Here, the differences L1−L0 and L2−L1 represent change amounts within the predetermined time Tw and can be deemed as change rates. In other words, the change rate of a received signal from the antenna A is compared with that of a received signal from the antenna B and one of these antennas which is associated with a larger change rate is selected as a reception antenna.

FIG. 13A depicts an output waveform of averaging filter 350 when the antenna A is in association with a higher received signal level. Since the received signal level in the antenna A is higher, the antenna is switched from B to A at the time that the second measurement has ended. Accordingly, the output of averaging filter 350 rises at a higher rate, that is, the change rate increases after the timing TM5 as shown in FIG. 13A. On the other hand, FIG. 13B depicts an output waveform of averaging filter 350 when the antenna B is at a higher received signal level. Since the received signal level at the antenna B is higher, the antenna B remains to be selected at the time that the second measurement has ended. Accordingly, the output of averaging filter 350 rises at a constant rate, that is, at the same rate as shown in FIG. 13B.

When the antenna A is at the higher received signal level as shown in FIG. 13A, the output of averaging filter 350 is fetched into the system control circuit 370 as a third measured value at the termination of a predetermined delay time Td1 following the timing TM5 at which the antenna is switched. When the antenna B assumes the higher received signal level as shown in FIG. 13B, the output of averaging filter 350 is fetched into the system control circuit 370 as a third measured value at the termination of the predetermined delay time Td1 following initial switching of the antenna from A to B. Through this, in case the received signal level at the antenna selected afterward as shown in FIG. 13B is higher, the third measured value can be obtained earlier by predetermined time Tw.

Then, the system control circuit 370 determines the rough gain on the basis of the third measured value by the first measuring circuit 280 and transmits the DC offset cancel control signal OCS1 as well as control data WD1 inclusive of the gain setting codes GS0 to GS2 and control data WD2 inclusive of the gain setting codes GS10 to GS13 to the radio-frequency IC at a timing TM6. But a bit CAL in control data WD2 for designating calibration of the third stage of amplifier PGA3 is set to “0” (i.e., no calibration).

In accordance with the control data WD1, gains of the low-noise amplifier 221, IF amplifier 222 and first and second stages of amplifiers PGA1 and PGA2 in high-gain amplifiers 240a and 240b are set. This is accomplished while the signal during the short symbol period Tf1 in FIG. 12 is received. In this phase, however, the gain of the third stage of amplifier PGA3 is set to a lower value determined in advance (for example, 0 db).

Thereafter, the system control circuit 370 causes the second measuring circuit 360 to start measurement of the received signal level, settles the measured value at a timing TM7 to determine precise gains on the basis of the settled measured value and transmits a DC offset cancel control signal OCS1 as well as control data WD1 and WD2 including gain setting codes GS0 to GS2 and GS10 to GS14, respectively, to the radio-frequency IC 200. Through this, gains of the low-noise amplifier 221, IF amplifier 222 and individual stages of amplifiers PGA1, PGA2 and PGA3 of high-gain amplifiers 240a and 240b are set precisely. This is accomplished while the signal during the long symbol period Tf2 in FIG. 12 is received. In this phase, the bit CAL in second control data WD2 for designating calibration of the third stage of amplifier PGA3 is set to “i” (i.e., calibration execution), so that offset cancel operation of the third stage of amplifier PGA3 is executed on real time base.

In FIG. 12, the short symbol period Tf1 (8 μs) and the succeeding long symbol period Tf2 (8 μs) constitute a common portion of packet head and the head portion and the succeeding symbol period Tf3 (4 μs) consisting of guard interval area GI and signal area SIGNAL exist in a packet without fail. On the other hand, symbol periods (4 μs) Tf4, Tf5 . . . succeeding the symbol period Tf3 and each consisting of guard interval area GI and data area Data constitute a data portion which differs with specifications of a packet.

In the radio-frequency IC 200 and baseband LSI circuit 300 in the present embodiment, the control data WD for setting gains from the system control circuit 370 to the gain control circuit 251, on the one hand, is transmitted in a parallel data transmission fashion because the gain setting must be completed within a very short period of time during reception operation start and on the other hand, the control data WD supplied from system control circuit 370 to radio-frequency IC 200 for setting amplifier gains is set to 5 bits with a view to decreasing the number of external terminals. Accordingly, it is difficult for one control data to designate gains of all of the circuits. Therefore, the control data used for setting is divided into two parts WD1 and WD2.

According to teachings of the present embodiment, in the radio communication system having the plurality of antennas so that a received signal may be selected by either of the antennas in accordance with a reception state and may be amplified and demodulated, a proper antenna can be selected without being affected by amplitude noises contained in the received signal. Further, a proper antenna can be selected without using expensive, external parts such as SAW filter to thereby reduce the number of parts constituting the system and the cost. In addition, a proper antenna can be selected within a short period of time and besides gain setting in the reception-system circuit for amplification and demodulation of the received signal can be completed within a short period of time.

The invention made by the present inventor has been described concretely on the basis of embodiments but the invention is in no way limited to the foregoing embodiments and can be changed and modified without departing from the gist of the present invention. For example, while in the foregoing embodiments the antenna switchover switch 110 is switched with the control signal from the control circuit 370 of baseband LSI circuit 300 but a decision circuit comprised of a circuit similar to the AD conversion circuit 311c and averaging filter 350 as shown in FIG. 1 and a simplified logic circuit may be provided in the radio-frequency IC 200 or the control circuit 252 may be made to have the function as above, thereby ensuring that the switchover signal for the antenna switchover switch 110 can be provided from the radio-frequency IC 200. In the foregoing embodiments the number of the antennas is described as being two but the present invention can be applied to the case where three or more antennas are provided.

While in the foregoing embodiments the antenna switchover switch 110 is provided externally of the chip of radio-frequency IC 200 but a plurality of low-noise amplifiers 221 may be provided in correspondence with the antennas, respectively, and a switchover switch for selecting the output of any one of the low-noise amplifiers in accordance with the received level may be provided in the radio-frequency IC 200 or other low-noise amplifiers than a desired low-noise amplifier may be deactivated.

Further, in the foregoing embodiments, of the two measurement operations for selection of an antenna to be used, the second measurement is carried out continuously to the first measurement while keeping the state immediately after the first measurement intact but the averaging filter 350 may be reset immediately after the first measurement and then the second measurement may be started. The averaging filter 350 is not limited to the construction shown in FIG. 6 and an IIR filter, a switched capacitor filter or another analog filter having a delay means, an adder and a feedback loop may be used.

In the foregoing description, the invention made by the present inventor has been described as being applied to the wireless LAN system representing the utilization field giving the background of this invention and to the radio-frequency IC and baseband LSI circuit constituting the system but the present invention is in no way limited thereto and can be applied to, for example, a radio communication system such as a cellular phone based on the W-CDMA scheme and to radio-frequency IC and baseband LSI circuit constituting the system.

It should be further understood by those skilled in the art that although the foregoing description has been made on embodiments of the invention, the invention is not limited thereto and various changes and modifications may be made without departing from the spirit of the invention and the scope of the appended claims.

1. A radio communication system comprising:
a plurality of antennas;
a reception-system circuit including variable gain amplification circuits for amplifying a signal received by either of said plurality of antennas and a frequency conversion circuit for down-converting the received signal to a signal of a lower frequency;
a signal measuring circuit for detecting intensity of the received signal; and
a control circuit for determining change rates with time of a signal which is formed by said signal measuring circuit in respect of each of the signals received by said plurality of antennas and generating a signal for selecting a reception antenna in accordance with a difference between the change rates of the signals received by said plurality of antennas.

2. A radio communication system according to claim 1, wherein the circuit for forming said signal for which change rates are determined is a filter circuit.

3. A radio communication system according to claim 2, wherein said filter circuit is an averaging filter for sequentially adding sampling values of a received signal inputted within a predetermined time.

4. A radio communication system according to claim 3, wherein after the output of said averaging filter has converged, gain setting for said variable gain amplification circuits is carried out.

5. A radio communication system according to claim 1, wherein after switchover of the antennas based on the result of selection of said reception antennas has ended, gain setting for said variable gain amplification circuits is carried out.

6. A radio communication system according to claim 1, wherein said reception-system circuit and signal measuring circuit are formed on a first semiconductor chip and said control circuit is formed on a second semiconductor chip.

7. A radio communication system according to claim 1, wherein said reception-system circuit and signal measuring circuit are formed on a first semiconductor chip and said control circuit and said filter circuit are formed on a second semiconductor chip.

8. A radio communication system according to claim 1, wherein said reception-system circuit, signal measuring circuit and control circuit are formed on the same semiconductor chip.

9. A radio communication system according to claim 1,
wherein said signal measuring circuit detects intensity of a received signal on the basis of output signals of said frequency conversion circuit,
wherein said reception-system circuit further includes a demodulation circuit for synthesizing two quadrature signals 90° dephased from each other and the received signal so as to demodulate an I signal of a component in phase with a fundamental wave and a Q signal of a quatrature component, a first amplification circuit of variable gain for amplifying the I signal demodulated by said demodulation circuit to a desired level, a second amplification circuit of variable gain for amplifying the Q signal demodulated by said demodulation circuit to a desired level, and a second signal measuring circuit for detecting intensity of the received signal on the basis of output signals of said first and second amplification circuits, and
wherein after said reception antenna selection has been completed, gain setting for said first and second amplification circuits is carried out on the basis of an output signal of said second signal measuring circuit.

10. A radio communication system according to claim 9, wherein after antenna switchover based on the result of reception antenna selection has been ended, first gain setting for said first and second amplification circuits based on the output signal of said signal measuring circuit is carried out and thereafter, second gain setting for said variable gain amplification circuits based on the output signal of said second signal measuring circuit is carried out.

11. A radio communication system according to claim 9, wherein said frequency conversion circuit, first amplification circuit, second amplification circuit and signal measuring circuit are formed on a first semiconductor chip and said control circuit and said second signal measuring circuit are formed on a second semiconductor chip.

12. A radio communication system according to claim 9,
wherein said signal measuring circuit includes addition means for adding I and Q signals, a low-pass filter, a detection circuit, an AD conversion circuit and an averaging filter, and
wherein said addition means, low-pass filter and detection circuit are formed on a first semiconductor chip and said AD conversion circuit, averaging filter, control circuit and second signal measuring circuit are formed on a second semiconductor chip.

13. A radio-frequency IC comprising:
a reception-system circuit including variable gain amplification circuits for amplifying a signal received by either of plural antennas and a frequency conversion circuit for down-converting the received signal to a signal of a lower frequency;
a signal measuring circuit for detecting intensity of the received signal; and
a control circuit for determining change rates with time of a signal which is formed by said signal measuring circuit in respect of either of the signals received by said plural antennas and generating a signal for selection of a reception antenna in accordance with a difference between the change rates.

14. A radio-frequency IC according to claim 13, wherein the circuit for forming said signal for which the change rates are determined is a filter circuit.

15. A radio-frequency IC according to claim 14, wherein said filter circuit is an averaging filter for sequentially adding sampling values of a received signal inputted within a predetermined time.

16. A radio-frequency IC according to claim 15, wherein after the output of said averaging filter has converged, gain setting for said variable gain amplification circuits is carried out.

17. A radio-frequency IC according to claim 13, wherein after switchover of the antennas based on the result of selection of said reception antenna has ended, gain setting for said variable gain amplification circuits is carried out.

18. A radio-frequency IC according to claim 13, wherein said signal for which change rates are determined is down-converted to a baseband frequency band.
